(19) United States
(12) Patent Application Publication
(10) Pub. No.: US 2002/0146004 A1
(43) Pub. Date: Oct. 10, 2002

(54) Nominal data flow path-based, virtual function configured frame relay state machine

(75) Inventors: David Perkinson, Madison, AL (US); Gaylon Buckelew, Eva, AL (US); Michael J. Norton, Huntsville, AL (US)

Correspondence Address: CHRISTOPHER F. REGAN, ESQUIRE, ALLEN, DYER, DOPPELT, MILBRATH & GILCHRIST, P.A., P.O. Box 3791, Orlando, FL, 32802-3791, US

(73) Assignee: ADTRAN, INC., Huntsville, AL (US)

(21) Appl. No.: 09/825,703

(22) Filed: Apr. 4, 2001

(51) Int. Cl. H04L 12/28

(52) U.S. Cl. 370/389; 370/392

(57) ABSTRACT

A packet flow control mechanism for a frame engine of a packet switch has a reduced complexity set of ‘nominal’ data flow path-based virtual functions, that process a packet based upon the state of the individual port. Code for the virtual function set can be installed in the instruction cache, by taking advantage of the fact that, once it has reached its steady state operation, the switch's frame engine can be expected to route packets over the nominal data flow path, with no conditional branching or function replacement. The actual function to which a respective virtual function points are dependent upon the signaling state and the level of congestion. For conditional branches, the frame engine may reference auxiliary memory, which stores a conditional state-based processing routine for handling exceptions to the nominal case.

### FIELD OF THE INVENTION

The present invention relates in general to communication networks and systems employed for the transport of digital telecommunication signals, and is particularly directed to a virtual function configured packet flow control mechanism, that is operative to execute a nominal data flow path case routine stored in the frame engine's instruction cache, and thereby enhance the speed at which digital data packets may be routed through a frame relay network packet switch.

### BACKGROUND OF THE INVENTION

Digital communication systems enable telecommunication service providers (for example, a competitive local exchange carrier (CLEC), such as an internet service provider (ISP)), to supply various types of high speed digital service over network circuits of an incumbent local exchange carrier (ILEC), such as a Bell operating company (RBOC), serving a number of customer premises equipments (CPEs) having a wide range of operational bandwidths and digital subscriber line termination capabilities. FIG. 1 shows a reduced complexity example of such a digital communication network architecture as comprising a PCM communication link (such as an optical fiber) 10, through which a network (cloud) 12 at a ‘west’ end of the link 10 transmits and receives digital telecommunication signals (e.g., packetized T3 traffic) with respect to customer premises equipments (CPEs) served by a remote termination site (RTS) 30 at an ‘east’ end of the PCM link 10.

In order to route packets among the virtual circuits of the network, the network commonly employs one or more frame relay-based packet switches, a simplified diagram of one of which is shown at 20 in FIG. 2 as having multiple input ports Pi-1, . . . , Pi-N and multiple output ports Po-1, . . . , Po-N thereof coupled to associated virtual circuits (VCs). In order to filter and selectively route or steer packets through the frame relay switch 20, its associated frame engine, as executed by a programmed control processor and attendant memory, shown at 22, is operative to analyze the contents of a respective packet presented to (an input port Pi-i of) the switch, and then selectively route the packet to the appropriate output port Po-j, based upon the results of that analysis.

Because it has been customary practice to configure the frame engine's analysis routine as a fully embedded scheme that is intended to accommodate all possible conditional states, it can be very complex and requires many lines of code. This mandates the use of a relatively powerful and costly processor as well as substantial memory, continual reference to which limits the speed with which a packet may be analyzed and routed.

### SUMMARY OF THE INVENTION

In accordance with the present invention, this problem is successfully remedied by taking advantage of the fact that, once it has reached its steady state operation, the switch's frame engine can be expected, for the most part, to route an incoming packet over what may be termed a ‘nominal’ data flow path, that encounters no conditional branching or function replacement. This enables the data flow path processing routine to be defined by a reduced complexity set of virtual functions, that are adapted to process the packet based upon the state of the individual port. The actual function to which a respective virtual function points will be dependent upon the signaling state and the level of congestion.

For the nominal data flow path case, the set of virtual functions required can be specified in a relatively small number of lines of code, so that they can be readily stored in a reduced size memory, such as the frame engine's instruction cache. The ability to store the most frequently encountered data flow path sequence in the instruction cache means that the processing speed of the frame engine can be significantly increased. In addition, it reduces the complexity of the processor required. Where conditional branches are encountered, the frame engine may reference auxiliary memory, in which a conditional state-based processing routine for handling exceptions to the nominal case is stored. This auxiliary routine may be configured as a conventional conditional state-embedded routine. Still, branching outside the instruction cache is an occasional event rather than the norm, the overall processing speed provided by the invention is still considerably improved over a fully embedded frame engine routing mechanism.

### BRIEF DESCRIPTION OF THE DRAWINGS

FIG. 1 is a reduced complexity example of a digital communication network architecture;

FIG. 2 is a simplified diagram of a frame relay-based packet switch; and

FIG. 3 is a diagrammatic illustration of the virtual function configured packet flow control mechanism in accordance with the present invention.

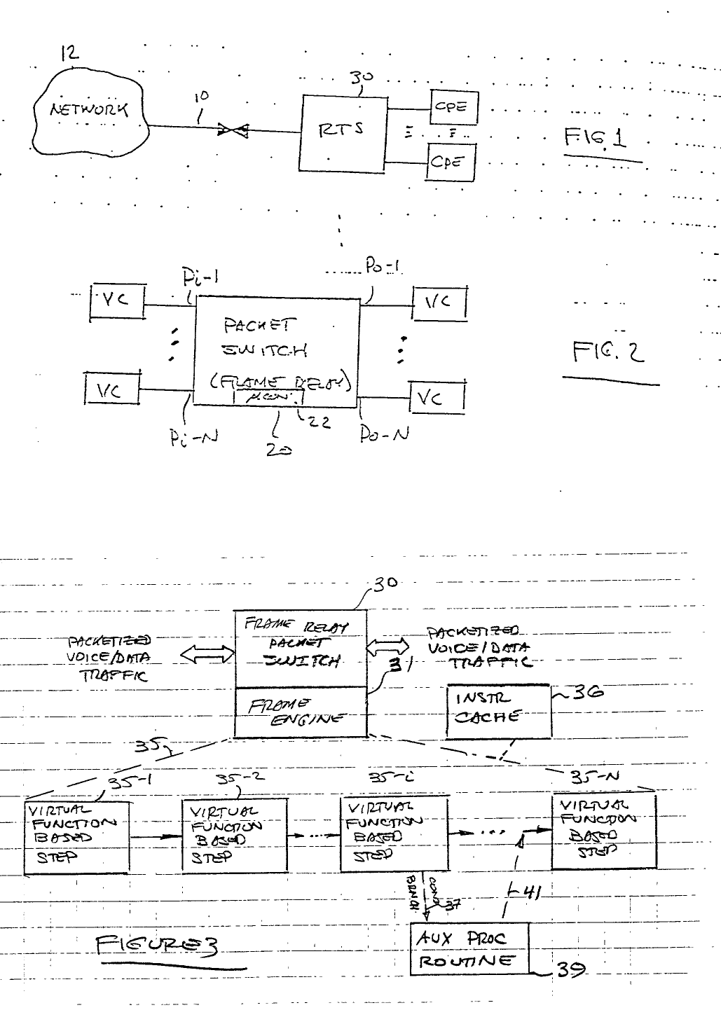

### DETAILED DESCRIPTION

Before describing in detail the virtual function configured packet flow control mechanism of the present invention, it should be observed that the invention resides primarily in what is effectively a prescribed digital data communication control mechanism, that is executable by the hardware and software of supervisory communications control components of conventional digital communication circuitry, including digital signal processing components and attendant supervisory control circuitry therefor, that controls the operations of such circuits and components.

As a consequence, the configuration of such circuits and components and the manner in which they are interfaced with other communication system equipment have, for the most part, been illustrated by readily understandable block diagrams, which show only those specific details that are pertinent to the present invention, so as not to obscure the present disclosure with details which will be readily apparent to those skilled in the art having the benefit of the description herein. Thus, the diagrammatic illustrations are primarily intended to show the major components and functional operations of the invention in the context of a present day digital communication network in a convenient functional grouping, whereby the present invention may be more readily understood.

Referring now to FIG. 3, the packet flow control mechanism of the invention, that is employed by the frame engine 31 of a frame relay network packet switch 30, for controlling the port-coupling or data flow or routing path through the switch, is diagrammatically illustrated as comprising a sequence 35 of virtual function-based steps 35-1, 35-2, . . . , 35-N, that are configured to process a respective packet based upon the state of the individual port. As pointed out above, the actual function to which a respective virtual function 35-i points is dependent upon the signaling state and the level of congestion.

Pursuant to the invention, the set of virtual functions is associated with the nominal data path case, which may be determined a priori, or as the result of the frame engine having been up and running and settled into a steady state mode of operation (that is not ‘cluttered’ with conditional branching decisions), in which data packets are routed over a predictable data path through the switch. In either case, the composition of the ‘nominal’ data path associated virtual function set is relatively condensed, and readily be specified in a very reduced number (e.g., on the order of multi-tens) of lines of code. This allows the virtual function set to be stored in a very small amount of memory.

In accordance with a preferred by non-limiting embodiment, the nominal data path virtual function set 35 is written into the frame engine's instruction cache, shown in broken lines 36. As mentioned earlier, this not only enables processing speed of the frame engine to be significantly increased, but serves to reduce the complexity of the processor. In the case that the virtual function set associated with the nominal case data flow path is determined, a priori, the frame engine's instruction cache may be sized to include a dedicated portion for the storage of the reduced code set for the nominal case.

Should processing of a packet require reference to a conditional branch, such as that shown by broken lines 37, the data path routing mechanism references an attendant memory 3, in which an auxiliary processing routine 39 for handling exceptions to the nominal case of the virtual set 35 is stored. As pointed out above, this auxiliary processing routine 39 may be configured as a conventional conditional state-embedded program. Once completed, the conditional branch returns to the next step in the virtual path of the instruction cache, as denoted by broken lines 41.

As will be appreciated from the foregoing description, the virtual function based data flow path control mechanism of the invention obviates the problems associated with the use of a condition-embedded packet routing scheme, by taking advantage of the fact that, at steady state, the packet switch's frame engine can be expected to route a packet over a ‘nominal’ data path, in which no conditional branching or function replacement is encountered. As a consequence, the data flow path routine of the invention may be readily defined by a reduced complexity set of virtual functions, that process the packet based upon the state of the individual port. The actual function to which a respective virtual function points will be dependent upon the signaling state and the level of congestion.

While we have shown and described an embodiment in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

What is claimed:

1. A method of selectively coupling digital communication packets, that are presented to virtual circuit input ports of a packet switch, through said switch to virtual circuit output ports thereof, said method comprising the steps of:
(a) providing a packet analysis mechanism, which is operative to analyze contents of a packet presented to said packet switch and to controllably route said respective packet to a selected virtual circuit output port of said packet switch, said packet analysis mechanism being configured as a virtual function packet flow control mechanism which is operative to execute a prescribed data flow path routine that calls successive virtual functions, which nominally encounter no conditional branching or function replacement; and
(b) presenting a packet coupled to a virtual circuit input port to said packet analysis mechanism and thereby causing said packet to be routed to a virtual circuit output port of said packet switch.

2. The method according to claim 1, wherein step (a) comprises storing said packet analysis mechanism in an instruction cache of a communication control processor of a frame engine for said packet switch.

3. the method according to claim 2, wherein step (a) further includes storing in memory exclusive of said instruction cache an auxiliary processing routine that is configured to handle exceptions to the nominal data flow path of said packet analysis mechanism.

4. A packet switch control mechanism for controlling the selective coupling of digital communication packets presented to virtual circuit input ports of a packet switch to virtual circuit output ports thereof comprising:
a packet routing control processor for said packet switch, including an instruction cache; and
a packet analysis mechanism, stored in said instruction cache and being operative to analyze contents of a packet presented to said packet switch and to controllably route said respective packet to a selected virtual circuit output port of said packet switch, said packet analysis mechanism being configured as a virtual function packet flow control mechanism which is operative to execute a prescribed data flow path routine that calls successive virtual functions, which nominally encounter no conditional branching or function replacement.

5. The packet switch control mechanism according to claim 4, further including memory exclusive of said instruction cache for storing an auxiliary processing routine that is configured to handle exceptions to the nominal data flow path of said packet analysis mechanism.
